(19) United States
(12) Patent Application Publication
(10) Pub. No.: US 2016/0214526 A1
(43) Pub. Date: Jul. 28, 2016

(54) LIGHTED SPARE TIRE COVER

(71) Applicant: CESAR OTERO, Orlando, FL (US)

(72) Inventor: CESAR OTERO, Orlando, FL (US)

(21) Appl. No.: 14/606,412

(22) Filed: Jan. 27, 2015

(51) Int. Cl. B60Q 1/26; B60Q 1/30; B60Q 1/44; B62D 43/02

(52) U.S. Cl. CPC B60Q 1/2661; B62D 43/02; B60Q 1/30; B60Q 1/44

(57) ABSTRACT

The lighted spare tire cover is configured to be installed on a rear-mounted spare tire. The lighted spare tire cover includes a planar surface that may include a logo thereon. The logo on the planar surface may be illuminated via at least one light member. The lighted spare tire cover is also adapted to be in wired connection with a vehicle lighting system and/or a vehicle brake light such that the logo is illuminated when the vehicle lighting system and/or vehicle brake light is illuminated. The lighted spare tire cover includes a processing member in wired connection with the light member, and the vehicle lighting system and/or vehicle brake light.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of tire covers, more specifically, a tire cover that includes a logo integrated into a planar surface that is able to be illuminated.

### SUMMARY OF THE INVENTION

The lighted spare tire cover is configured to be installed on a rear-mounted spare tire. The lighted spare tire cover includes a planar surface that may include a logo thereon. The logo on the planar surface may be illuminated via at least one light member. The lighted spare tire cover is also adapted to be in wired connection with a vehicle lighting system and/or a vehicle brake light such that the logo is illuminated when the vehicle lighting system and/or vehicle brake light is illuminated. The lighted spare tire cover includes a processing member in wired connection with the light member, and the vehicle lighting system and/or vehicle brake light.

These together with additional objects, features and advantages of the lighted spare tire cover will be readily apparent to those of ordinary skill in the art upon reading the following detailed description of presently preferred, but nonetheless illustrative, embodiments of the lighted spare tire cover when taken in conjunction with the accompanying drawings.

In this respect, before explaining the current embodiments of the lighted spare tire cover in detail, it is to be understood that the lighted spare tire cover is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the lighted spare tire cover.

It is therefore important that the claims be regarded as including such equivalent construction insofar as they do not depart from the spirit and scope of the lighted spare tire cover. It is also to be understood that the phraseology and terminology employed herein are for purposes of description and should not be regarded as limiting.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention:

In the drawings:

FIG. 1 illustrates a perspective view of an embodiment of the disclosure.

FIG. 2 illustrates a side view of an embodiment of the disclosure.

FIG. 3 illustrates a detailed back view of an embodiment of the disclosure.

FIG. 4 illustrates a front view of the planar surface of an embodiment of the disclosure.

FIG. 5 illustrates a view of an embodiment of the disclosure in use.

FIG. 6 illustrates a detailed cut-away view of the logo of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

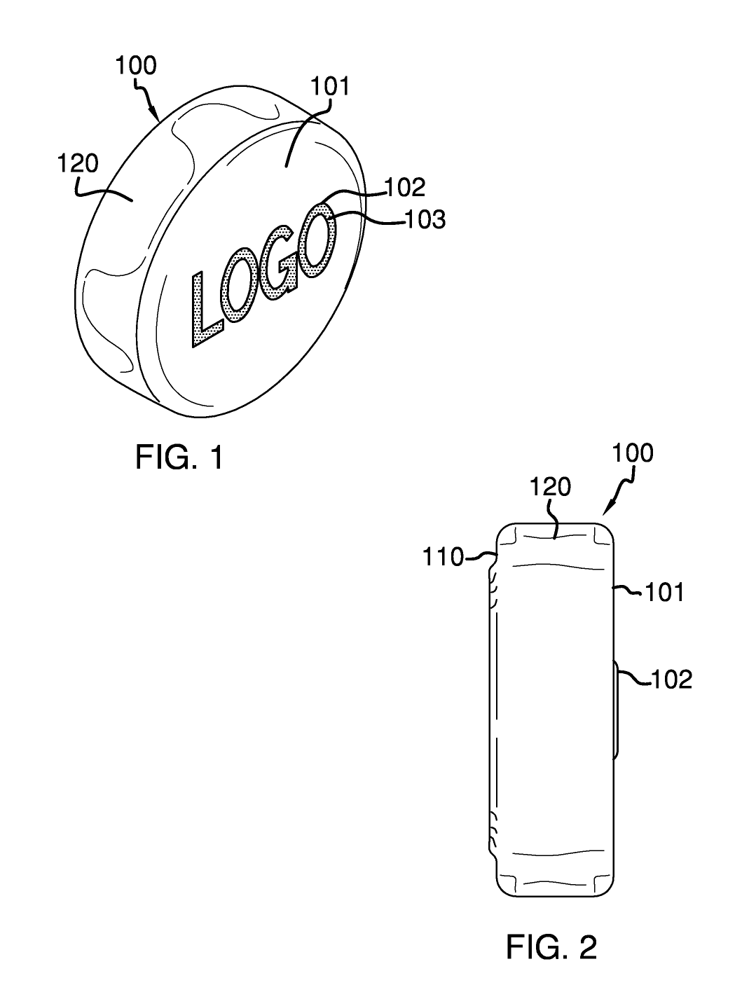

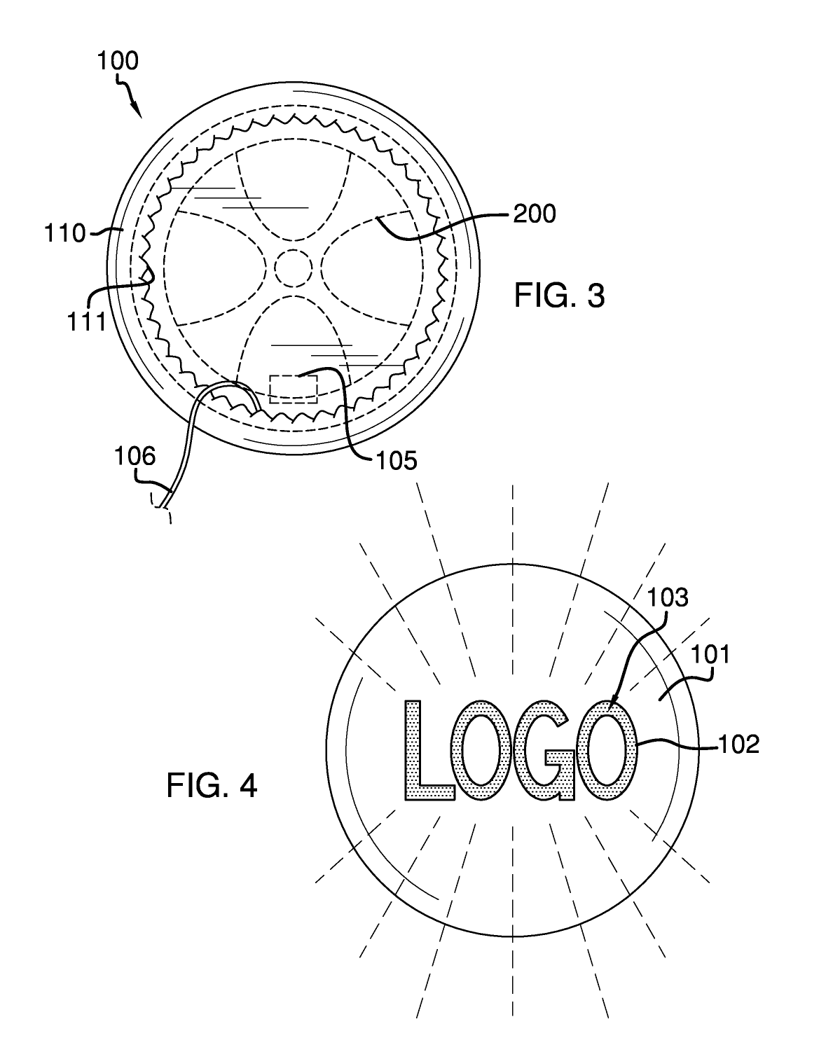

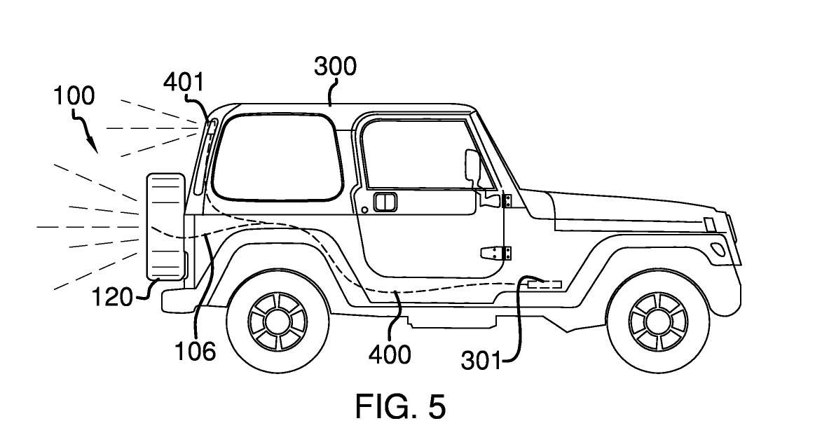

Detailed reference will now be made to the preferred embodiment of the present invention, examples of which are illustrated in FIGS. 1-6. A lighted spare tire cover 100 (hereinafter invention) is further defined with a planar surface 101 that may include a logo 102 thereon. The invention 100 is configured to cover a rear-mounted spare tire 200. Moreover, the planar surface 101 is adapted to be facing rearward with respect to a vehicle 300.

The logo 102 located on the planar surface 101 is outfitted with at least one light member 104. The at least one light member 104 is in wired communication with a central processing unit 105 that is in turn configured to be wired to a brake light wire 400 of said vehicle 300. Moreover, the central processing unit 105 includes a first wire 106 that is configured to directly connect with the brake light wire 400. The invention 100 is able to work in concert with a vehicular brake light 401 in order to illuminate the logo 102 upon depression of a brake pedal 301 of said vehicle 300.

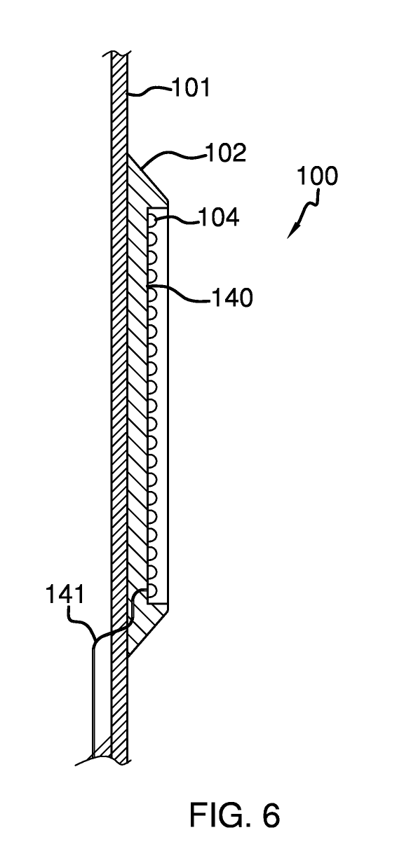

The at least one light member 104 is recessed inside of the logo 102. Referring to FIG. 6, the logo 102 extends outwardly from the planar surface 101. The logo 102 includes at least one recess 140 that outlines or renders the appearance of the logo 102. Located inside of the at least one recess 140 is the at least one light member 104. The at least one light member 104 may involve or use incandescent bulbs or light emitting diodes. The at least one light member 104 is connected to the central processing unit 105 via a second wire 141.

The invention 100 is further defined with a second planar surface 110 that is parallel with the planar surface 101. The second planar surface 110 includes a tire opening 111 thereon, which enables insertion of the rear-mounted spare tire 200. The invention 100 includes a perimeter surface 120 that attaches between the planar surface 101 and the second planar surface 110.

With respect to the above description, it is to be realized that the optimum dimensional relationship for the various components of the invention 100, to include variations in size, materials, shape, form, function, and the manner of operation, assembly and use, are deemed readily apparent and obvious to one skilled in the art, and all equivalent relationships to those illustrated in the drawings and described in the specification are intended to be encompassed by the invention 100.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A lighted spare tire cover comprising:
a planar surface into which a logo is integrated;
said logo includes at least one light member that adaptively illuminates in concert with a vehicular brake light of a vehicle in order to enhance the vehicular brake light function of said vehicle.

2. The lighted spare tire cover as described in claim 1 wherein the lighted spare tire cover is configured to cover a rear-mounted spare tire.

3. The lighted spare tire cover as described in claim 2 wherein the planar surface is adapted to be facing rearward with respect to said vehicle.

4. The lighted spare tire cover as described in claim 3 wherein the at least one light member is in wired communication with a central processing unit that is in turn configured to be wired to a brake light wire of said vehicle.

5. The lighted spare tire cover as described in claim 4 wherein the central processing unit includes a first wire that is configured to directly connect with the brake light wire; wherein the at least one light member illuminates in concert with the vehicular brake light in order to illuminate the logo upon depression of a brake pedal of said vehicle.

6. The lighted spare tire cover as described in claim 5 wherein the at least one light member is recessed inside of the logo; wherein the logo extends outwardly from the planar surface.

7. The lighted spare tire cover as described in claim 6 wherein the logo includes at least one recess that outlines or renders the appearance of the logo; wherein located inside of the at least one recess is the at least one light member.

8. The lighted spare tire cover as described in claim 7 wherein the at least one light member is connected to the central processing unit via a second wire.

9. The lighted spare tire cover as described in claim 8 wherein a second planar surface is parallel with the planar surface.

10. The lighted spare tire cover as described in claim 9 wherein the second planar surface includes a tire opening thereon, which is configured to enable insertion of the rear-mounted spare tire therein.

11. The lighted spare tire cover as described in claim 10 wherein a perimeter surface that attaches between the planar surface and the second planar surface.

12. A lighted spare tire cover comprising:
a planar surface into which a logo is integrated;
said logo includes at least one light member that adaptively illuminates in concert with a vehicular brake light of a vehicle in order to enhance the vehicular brake light function of said vehicle;
wherein the lighted spare tire cover is configured to cover a rear-mounted spare tire;
wherein the planar surface is adapted to be facing rearward with respect to said vehicle.

13. The lighted spare tire cover as described in claim 12 wherein the at least one light member is in wired communication with a central processing unit that is in turn configured to be wired to a brake light wire of said vehicle.

14. The lighted spare tire cover as described in claim 13 wherein the central processing unit includes a first wire that is configured to directly connect with the brake light wire; wherein the at least one light member illuminates in concert with the vehicular brake light in order to illuminate the logo upon depression of a brake pedal of said vehicle.

15. The lighted spare tire cover as described in claim 14 wherein the at least one light member is recessed inside of the logo; wherein the logo extends outwardly from the planar surface.

16. The lighted spare tire cover as described in claim 15 wherein the logo includes at least one recess that outlines or renders the appearance of the logo; wherein located inside of the at least one recess is the at least one light member; wherein the at least one light member is connected to the central processing unit via a second wire.

17. The lighted spare tire cover as described in claim 16 wherein a second planar surface is parallel with the planar surface; wherein the second planar surface includes a tire opening thereon, which is configured to enable insertion of the rear-mounted spare tire therein.

18. The lighted spare tire cover as described in claim 17 wherein a perimeter surface that attaches between the planar surface and the second planar surface.
